(19) United States
(12) Patent Application Publication
(10) Pub. No.: US 2023/0072533 A1
(43) Pub. Date: Mar. 9, 2023

(54) ORDINAL CLASSIFICATION THROUGH NETWORK DECOMPOSITION

(71) Applicants: Takehiko Mizoguchi, Princeton, NJ (US); Liang Tong, Lawrenceville, NJ (US); Zhengzhang Chen, Princeton Junction, NJ (US); Wei Cheng, Princeton Junction, NJ (US); Haifeng Chen, West Windsor, NJ (US); Nauman Ahad, Atlanta, GA (US)

(72) Inventors: Takehiko Mizoguchi, Princeton, NJ (US); Liang Tong, Lawrenceville, NJ (US); Zhengzhang Chen, Princeton Junction, NJ (US); Wei Cheng, Princeton Junction, NJ (US); Haifeng Chen, West Windsor, NJ (US); Nauman Ahad, Atlanta, GA (US)

(21) Appl. No.: 17/896,747

(22) Filed: Aug. 26, 2022

Related U.S. Application Data
(60) Provisional application No. 63/237,547, filed on Aug. 27, 2021.

(51) Int. Cl. G06K 9/62; G06N 3/08

(52) U.S. Cl. CPC G06K 9/6269; G06K 9/628; G06K 9/6259; G06N 3/08

(57) ABSTRACT

A computer-implemented method for ordinal classification of input data is provided. The method includes learning, by an encoder neural network, compact neural representations of the input data. The method further includes freezing the encoder neural network for downstream tasks. The method also includes training, by a hardware processor, K−1 ordinal classifiers on top of the compact neural representations to obtained trained K−1 ordinal classifiers. The method additionally includes generating, by the hardware processor, a predicted ordinal label by aggregating the trained K−1 ordinal classifiers.

### RELATED APPLICATION INFORMATION

This application claims priority to U.S. Provisional Patent No. 63/237,547, filed on Aug. 27, 2021, incorporated herein by reference in its entirety.

### BACKGROUND

### Technical Field

The present invention relates to machine learning classification and more particularly to ordinal classification through network decomposition.

### Description of the Related Art

As compared to standard or nominal classification techniques, ordinal classification involves learning classification rules that respect the inherent order in target labels. A popular method for a classification problem with K ordinal labels is to decompose the problem into K−1 binary classes. The k-th binary classifiers try to predict if the given input is greater than or smaller than the k-th label. Results from all of these binary classifiers are aggregated to produce the final prediction. To improve training efficiency, a common scheme is to train these K−1 binary classes on top of shared neural network representations. Unfortunately, such a scheme has many disadvantages: some of these binary classifiers involve highly imbalanced classes that can lead to long training times. Also, some of these binary classifiers can start overfitting while others are still training.

### SUMMARY

According to aspects of the present invention, a computer-implemented method for ordinal classification of input data is provided. The method includes learning, by an encoder neural network, compact neural representations of the input data. The method further includes freezing the encoder neural network for downstream tasks. The method also includes training, by a hardware processor, K−1 ordinal classifiers on top of the compact neural representations to obtained trained K−1 ordinal classifiers. The method additionally includes generating, by the hardware processor, a predicted ordinal label by aggregating the trained K−1 ordinal classifiers.

According to other aspects of the present invention, a computer program product for ordinal classification of input data is provided. The computer program product includes a non-transitory computer readable storage medium having program instructions embodied therewith. The program instructions are executable by a computer to cause the computer to perform a method. The method includes learning, by an encoder neural network of the computer, compact neural representations of the input data. The method further includes freezing the encoder neural network for downstream tasks. The method also includes training, by a hardware processor of the computer, K−1 ordinal classifiers on top of the compact neural representations to obtained trained K−1 ordinal classifiers. The method additionally includes generating, by the hardware processor, a predicted ordinal label by aggregating the trained K−1 ordinal classifiers.

According to still other aspects of the present invention, a computer processing system for ordinal classification of input data is provided. The computer processing system includes a memory device for storing program code thereon. The computer processing system further includes a processor device, operatively coupled to the memory device, for running the program code to learn, by an encoder neural network implemented by the processor device, compact neural representations of the input data. The processor device further runs the program code to freeze the encoder neural network for downstream tasks. The processor device also runs the program code to train K−1 ordinal classifiers on top of the compact neural representations to obtained trained K−1 ordinal classifiers. The processor device additionally runs the program code to generate a predicted ordinal label by aggregating the trained K−1 ordinal classifiers.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing an exemplary computing device, in accordance with an embodiment of the present invention;

FIG. 2 is a block diagram showing an exemplary architecture of an ordinal time series classification framework, in accordance with an embodiment of the present invention;

FIG. 3 is a flow diagram showing an exemplary method for ordinal classification through network decomposition, in accordance with an embodiment of the present invention;

FIG. 4 is a flow diagram showing an exemplary processing flow with possible sub-components, in accordance with an embodiment of the present invention; and

FIG. 5 is a diagram showing an exemplary Advanced Driver Assistance System, in accordance with an embodiment of the present invention.

### DETAILED DESCRIPTION OF PREFERRED EMBODIMENTS

Embodiments of the present invention are directed to ordinal classification through network decomposition.

Embodiments of the present invention propose a framework where the representation learning part is split from the ordinal classification task. Embodiments of the present invention first try to learn compact data representations before training K−1 classifiers on top. This leads to much shorter training, helps improve classification performance, and provides a flexible framework that can be useful for ordinal classification in additional settings such as semi-supervised ordinal classification.

The proposed method would be applicable to a variety of data domains, including but not limited to images, time series, and so forth.

In an embodiment, two inventive features can be considered to contribute to solving the problem.

The first inventive feature involves separately learning representations from learning the ordinal classifiers. We first use triplet loss to learn compact data representations. Learning these representations no longer involves a class imbalanced learning problem. When K−1 binary classifiers are trained on top, they require much lesser time to train (as compared to existing scenario where the shared representations and K−1 binary classifiers are jointly trained).

The second inventive feature involves the compact representations allowing the K−1 binary classifiers to attain much improved classification performance. These compact representations can be further utilized for semi-supervised ordinal classification.

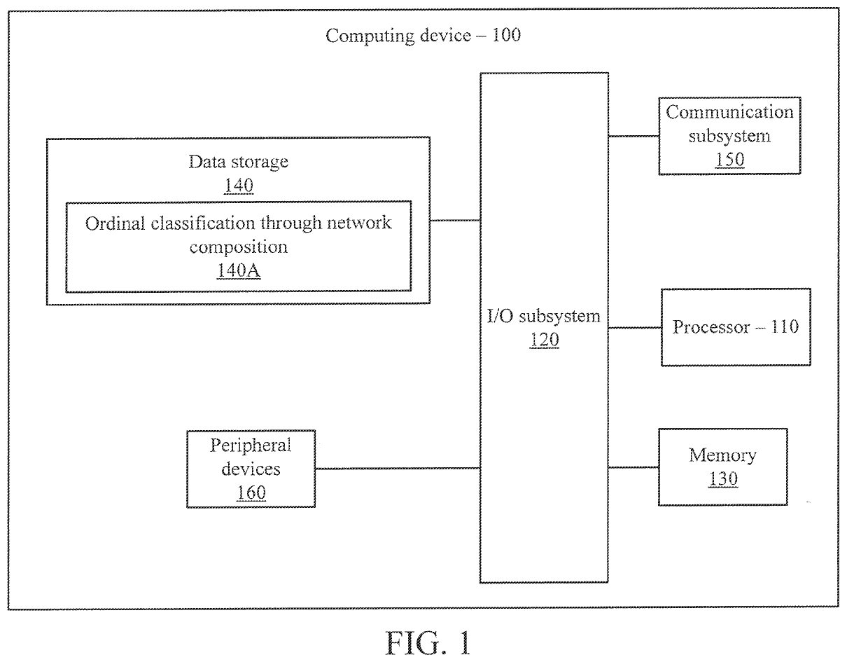

FIG. 1 is a block diagram showing an exemplary computing device 100, in accordance with an embodiment of the present invention. The computing device 100 is configured to perform ordinal classification through network decomposition.

The computing device 100 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 100 may be embodied as a one or more compute sleds, memory sleds, or other racks, sleds, computing chassis, or other components of a physically disaggregated computing device. As shown in FIG. 1, the computing device 100 illustratively includes the processor 110, an input/output subsystem 120, a memory 130, a data storage device 140, and a communication subsystem 150, and/or other components and devices commonly found in a server or similar computing device. Of course, the computing device 100 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 130, or portions thereof, may be incorporated in the processor 110 in some embodiments.

The processor 110 may be embodied as any type of processor capable of performing the functions described herein. The processor 110 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 130 may be embodied as any type of volatile or non-volatile memory or data storage capable of performing the functions described herein. In operation, the memory 130 may store various data and software used during operation of the computing device 100, such as operating systems, applications, programs, libraries, and drivers. The memory 130 is communicatively coupled to the processor 110 via the I/O subsystem 120, which may be embodied as circuitry and/or components to facilitate input/output operations with the processor 110 the memory 130, and other components of the computing device 100. For example, the I/O subsystem 120 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.) and/or other components and subsystems to facilitate the input/output operations. In some embodiments, the I/O subsystem 120 may form a portion of a system-on-a-chip (SOC) and be incorporated, along with the processor 110, the memory 130, and other components of the computing device 100, on a single integrated circuit chip.

The data storage device 140 may be embodied as any type of device or devices configured for short-term or long-term storage of data such as, for example, memory devices and circuits, memory cards, hard disk drives, solid state drives, or other data storage devices. The data storage device 140 can store program code for ordinal classification through network decomposition. The communication sub system 150 of the computing device 100 may be embodied as any network interface controller or other communication circuit, device, or collection thereof, capable of enabling communications between the computing device 100 and other remote devices over a network. The communication subsystem 150 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 100 may also include one or more peripheral devices 160. The peripheral devices 160 may include any number of additional input/output devices, interface devices, and/or other peripheral devices. For example, in some embodiments, the peripheral devices 160 may include a display, touch screen, graphics circuitry, keyboard, mouse, speaker system, microphone, network interface, and/or other input/output devices, interface devices, and/or peripheral devices.

Of course, the computing device 100 may also include other elements (not shown), as readily contemplated by one of skill in the art, as well as omit certain elements. For example, various other input devices and/or output devices can be included in computing device 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 100 are readily contemplated by one of ordinary skill in the art given the teachings of the present invention provided herein.

As employed herein, the term “hardware processor subsystem” or “hardware processor” can refer to a processor, memory (including RAM, cache(s), and so forth), software (including memory management software) or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention

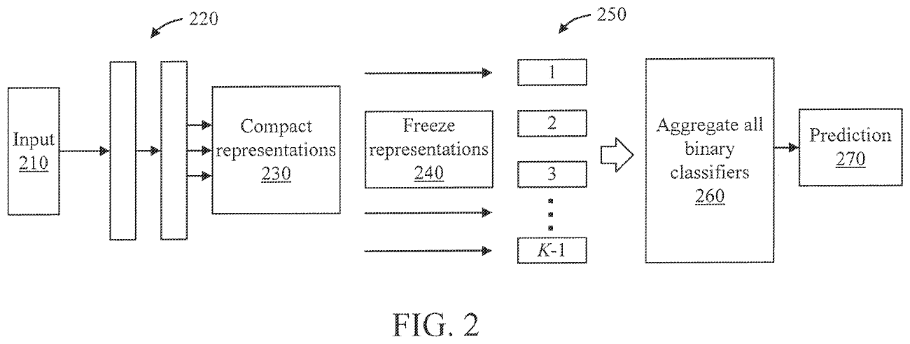

FIG. 2 is a block diagram showing an exemplary architecture 200 of an ordinal time series classification framework, in accordance with an embodiment of the present invention.

Given input data 210 that is to be classified in different ordinal categories, multiple neural network layers of an encoder network 220 are first used to learn compact representations 230 using triplet loss. Once these compact representations are learned, K−1 binary classifiers are trained 240 on top of these representations 230. The results 250 from all the different K−1 binary classifiers are aggregated 260 to make the final prediction 270.

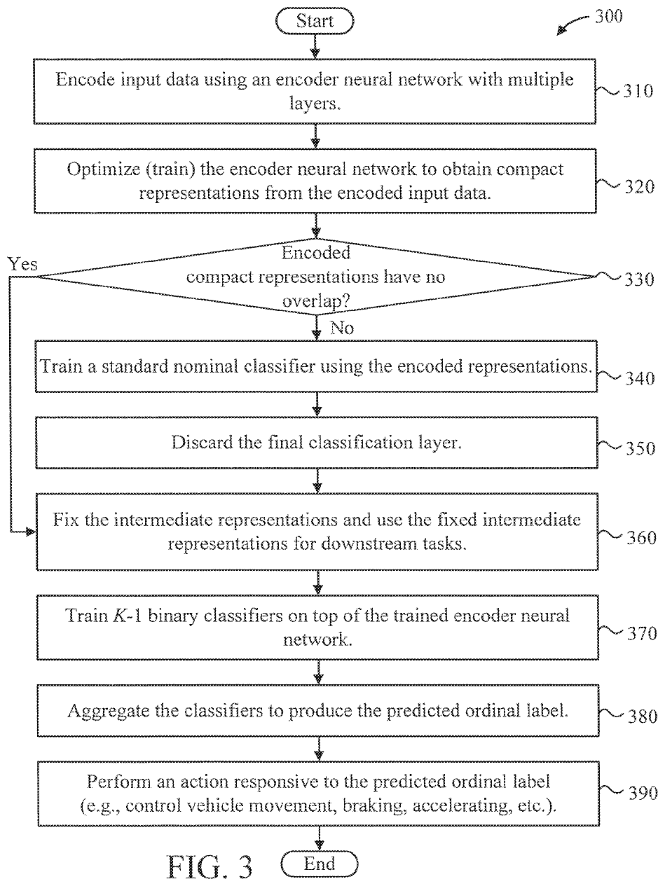

FIG. 3 is a flow diagram showing an exemplary method 300 for ordinal classification through network decomposition, in accordance with an embodiment of the present invention.

At block 310, encode input data using an encoder neural network with multiple layers.

It is to be appreciated that there is no restriction on the type of neural networks that can be used for the encoding. As the method of the present invention is intended to work with data from different domains, Long Short-Term Memories (LSTMs) can be used to encode temporal data, Convolutional Neural Networks (CNNs) can be used to encode image data, or fully connected multilayer neural networks can be used to encode other data domains. Gated Recurrent Units (GRUs), Recurrent Neural Networks (RNNs), and transformers can be used to perform the encoding depending upon the implementation.

At block 320, optimize (train) the encoder neural network to obtain compact representations from the encoded input data. It is to be appreciated that the encoder neural network will be trained by block 320. In an embodiment, block 320 uses a class-based approach to obtain the compact representations.

Normally, all training data has already been labeled before being used for training. There are two cases: The first one is the easy case, where the labels have an obvious inherent order. For example, if we want to predict the rate of a movie from 0, 1, 2, 3, 4, and 5, then the score itself includes ordering information thus can be directly used as labels. The second case is when the inherent order is not obvious. In this case, we label the data based on their semantic distance. For example, if we want to predict human activities such as “walk”, “sit”, “run”, and “stand”, we can label “sit” as “1”, ‘stand’ as “2”, “walk” as “3”, and “run” as “4”, as the semantic ordering should be “sit”-“stand”-“walk”-“run” (you can think that “walk” should be closer to “run” than “stand”).

A loss function is based on computing the delta between the actual and reconstructed input. An optimizer will try to train the encoder and a corresponding decoder to lower this reconstruction loss.

The goal of block 320 is to use the encoder of block 310 to obtain representations such that:

(a) Input data belonging to the same class should lie nearby in the encoded space (e.g., by a threshold amount). For this reason, we want to minimize the intra-class distance.

(b) Input data belonging to different classes should be far away in the encoded space (e.g., by a threshold amount). Ideally, input data belonging to different classes should not overlap in the encoded space.

To achieve these objectives, triplet loss can be used to learn the representations as follows:

L=max(∥f(x_{anc}−f(xₚₒₛ)∥²−∥f(x_{anc})−f(x_{neg})∥²+α,0)

where
x_{anc}: denotes an input sample
xₚₒₛ: denotes a sample which has the same label as the input
x_{neg}: denotes a sample which has a different label than the input
α: denotes a margin
f: denotes an encoder network

In other embodiments, cross-entropy loss and/or contrastive loss can be used in place of or in addition to triplet loss.

At block 330, determine if the encoded compact representations have no overlap. If so, proceed to block 360. Otherwise, proceed to block 340.

At block 340, train a standard nominal classifier using the encoded representations.

At block 350, discard the final classification layer.

At block 360, fix the intermediate representations and use the fixed intermediate representations for downstream tasks. As used herein “fix” means to not change the intermediate representations further.

At block 370, train K−1 binary classifiers on top of the trained encoder neural network. Here “on top” means that we “fix” the neural network that produces compact representation and make it as a fixed feature extractor. That is, data xᵢ is fed into the feature extractor f to get f(xᵢ) and then f(xᵢ) is used as the data to train the k−1 binary classifiers. This can be done by setting the weights of f as untrainable once they have been trained.

Once the representation learning encoder network is trained, K−1 binary classifiers are trained on top such that the kₜₕ binary classifier is given by zₖ and is defined as follows:

$${z}_{k} ( f ( {x}_{i} ) ) = \{ \begin{matrix}1 , if {y}_{i} > k \\ 0\end{matrix} ,$$

where:
xᵢ: denotes the iₜₕ input
yᵢ: denotes the ordinal label for xᵢ
k: denotes the number of the classifier being considered (out of K−1 classifiers).
f: denotes the encoder network trained in block 320

In an embodiment, the K−1 binary classifiers can be trained using cross-entropy loss and/or focal loss.

At block 380, aggregate the classifiers to produce the predicted ordinal label as follows:

\tilde{y}ᵢ=Σₖ₌₁^{K-1}zₖ(f(xᵢ))

where \tilde{y}ᵢ is the final decision of the classifier.

At block 390, perform an action responsive to the predicted ordinal label. The action can involve controlling a vehicle using an Advanced Driver Assistance System (ADAS). The control of the vehicle can involve braking, accelerating, steering, stability control, and so forth.

A significant contribution of method 300 is realizing the utility of first learning compact neural representations. K−1 ordinal classifiers are then trained on top of these representations. This splitting of the representation learning from the ordinal classification leads to much reduced training times.

A description will now be given regarding a flexible framework for additional ordinal classification tasks.

This framework where neural networks are trained to produce compact representations and then K−1 binary classifiers are trained on top is a very flexible framework that can be used for additional ordinal classification tasks.

One potential application is to leverage the compact representations for semi-supervised ordinal classification tasks. With compact representations, unlabeled data is expected to cluster to these compact representations resulting in improved performance for semi-supervised methods that can utilize pseudo labels. Additionally, self-supervised learning methods can utilize this framework, where the representation learning part is split from ordinal classification, to help learn better representations, while needing to utilize fewer number of labelled data points.

Disentangled representation learning methods could also be utilized to learn robust data representations that can help improve ordinal classification performance in the presence of distribution shifts (in spurious representation components that are not responsible for class labels).

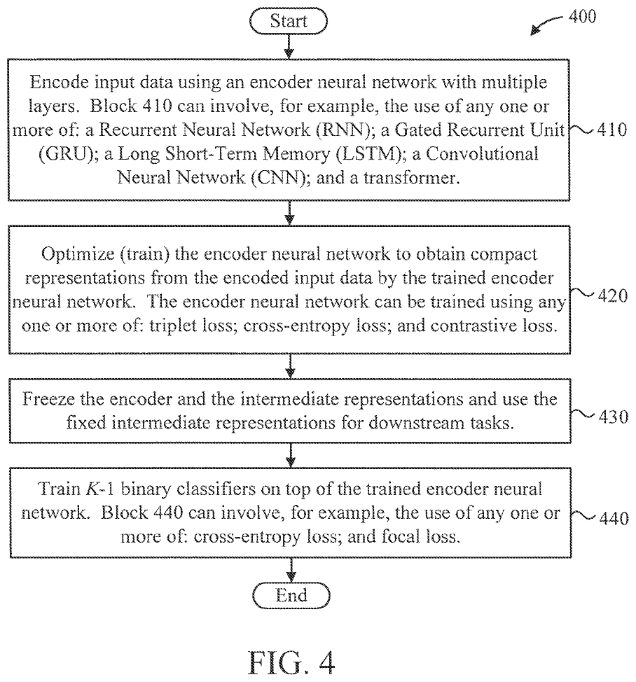

FIG. 4 is a flow diagram showing an exemplary processing flow 400 with possible sub-components, in accordance with an embodiment of the present invention.

At block 410, encode input data using an encoder neural network with multiple layers. Block 410 can involve, for example, the use of any one or more of: a Recurrent Neural Network (RNN); a Gated Recurrent Unit (GRU); a Long Short-Term Memory (LSTM); a Convolutional Neural Network (CNN); and a transformer.

At block 420, optimize (train) the encoder neural network to obtain compact representations from the encoded input data by the trained encoder neural network. The encoder neural network can be trained using any one or more of: triplet loss; cross-entropy loss; and contrastive loss.

At block 430, freeze the encoder and the intermediate representations and use the fixed intermediate representations for downstream tasks.

At block 440, train K−1 binary classifiers on top of the trained encoder neural network. Block 440 can involve, for example, the use of any one or more of: cross-entropy loss; and focal loss.

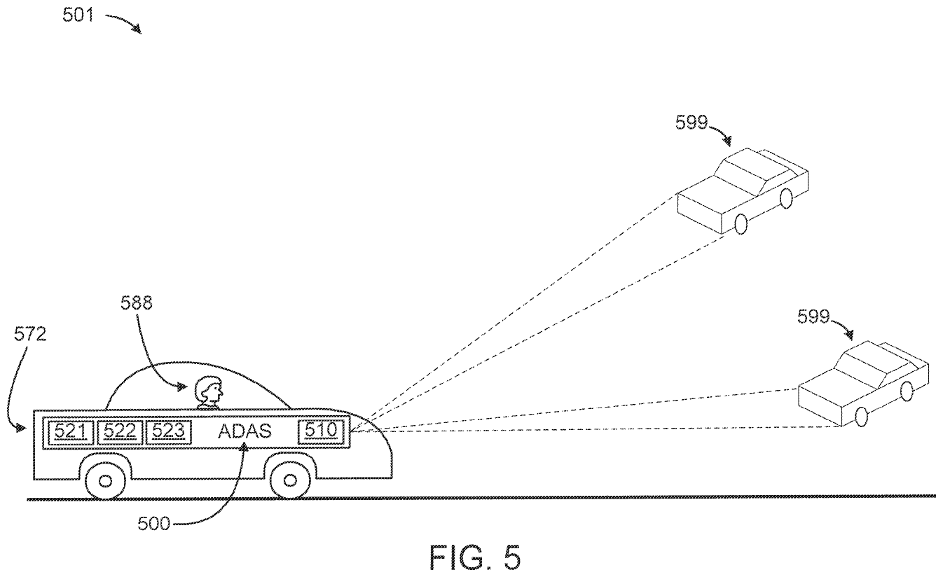

FIG. 5 is a diagram showing an exemplary Advanced Driver Assistance System 500, in accordance with an embodiment of the present invention.

The ADAS 500 is used in an environment 501 wherein a user 588 is located in a scene with multiple objects 599, each having their own locations and trajectories. The user 588 is operating a vehicle 572 (e.g., a car, a truck, a motorcycle, etc.).

The ADAS 500 includes a camera system 510. While a single camera system 510 is shown in FIG. 5 for the sakes of illustration and brevity, it is to be appreciated that multiple camera systems can be also used, while maintaining the spirit of the present invention. The ADAS 500 further includes a server 520 configured to perform object detection based on a ordinal prediction. The server 520 can include a processor 521, a memory 522, and a wireless transceiver 523. The processor 521 and the memory 522 of the remote server 520 can be configured to perform driver assistance functions based on predictions made from images received from the camera system 510 by the (the wireless transceiver 523 of) the remote server 520.

The ADAS 500 can interface with the user through one or more systems of the vehicle 572 that the user is operating. For example, the ADAS 500 can provide the user information (e.g., detected objects 599, their locations 599B, suggested actions, etc.) through a system 572A (e.g., a display system, a speaker system, and/or some other system) of the vehicle 572. Moreover, the ADAS 500 can interface with the vehicle 572 itself (e.g., through one or more systems of the vehicle 572 including, but not limited to, a steering system, a braking system, an acceleration system, stability, a steering system, etc.) in order to control the vehicle or cause the vehicle 572 to perform one or more actions. In this way, the user or the vehicle 572 itself can navigate around these objects 599 to avoid potential collisions there between.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for ordinal classification of input data, comprising:
learning, by an encoder neural network, compact neural representations of the input data;
freezing the encoder neural network for downstream tasks;
training, by a hardware processor, K−1 ordinal classifiers on top of the compact neural representations to obtained trained K−1 ordinal classifiers; and
generating, by the hardware processor, a predicted ordinal label by aggregating the trained K−1 ordinal classifiers.

2. The computer-implemented method of claim 1, wherein said training step trains the K−1 ordinal classifiers on top of the compact neural representations using a triplet loss.

3. The computer-implemented method of claim 1, wherein said training step trains the K−1 ordinal classifiers on top of the compact neural representations using a cross-entropy loss.

4. The computer-implemented method of claim 1, wherein said training step trains the K−1 ordinal classifiers on top of the compact neural representations using a contrastive loss.

5. The computer-implemented method of claim 1, wherein said training step comprises discarding a last classification layer of each of the K−1 ordinal classifiers responsive to the compact neural representations having at least some overlap.

6. The computer-implemented method of claim 1, wherein said learning step comprises optimizing the neural network encoder such that (a) input data belonging to a same class is close in an encoded space by a same class threshold amount, and (b) input data belonging to a different class is far in the encoded space by a different class threshold amount.

7. The computer-implemented method of claim 1, wherein said learning step comprises optimizing the neural network encoder further such that (c) the input data belonging to different classes does not overlap in the encoded space.

8. The computer-implemented method of claim 1, wherein the given input is a time series, and the neural network encoder comprises at least one Long Short-Term Memory (LSTM).

9. The computer-implemented method of claim 1, wherein said training step trains the K−1 binary classifiers such that a kₜₕ binary classifier is given by zₖ and is defined as:
$${z}_{k} ( f ( {x}_{i} ) ) = \{ \begin{matrix}1 , if {y}_{i} > k \\ 0\end{matrix} ,$$
where:
xᵢ: denotes the iₜₕ input;
yⱼ: denotes the ordinal label for xᵢ; and
k: denotes the number of the classifier being considered.

10. The computer-implemented method of claim 1, further comprising performing a semi-supervised ordinal classification task by clustering unlabeled data to at least some of the compact representations.

11. A computer program product for ordinal classification of input data, the computer program product comprising a non-transitory computer readable storage medium having program instructions embodied therewith, the program instructions executable by a computer to cause the computer to perform a method comprising:
learning, by an encoder neural network of the computer, compact neural representations of the input data;
freezing the encoder neural network for downstream tasks;
training, by a hardware processor of the computer, K−1 ordinal classifiers on top of the compact neural representations to obtained trained K−1 ordinal classifiers; and
generating, by the hardware processor, a predicted ordinal label by aggregating the trained K−1 ordinal classifiers.

12. The computer program product of claim 11, wherein said training step trains the K−1 ordinal classifiers on top of the compact neural representations using a triplet loss.

13. The computer program product of claim 11, wherein said training step trains the K−1 ordinal classifiers on top of the compact neural representations using a cross-entropy loss.

14. The computer program product of claim 11, wherein said training step trains the K−1 ordinal classifiers on top of the compact neural representations using a contrastive loss.

15. The computer program product of claim 11, wherein said training step comprises discarding a last classification layer of each of the K−1 ordinal classifiers responsive to the compact neural representations having at least some overlap.

16. The computer program product of claim 11, wherein said learning step comprises optimizing the neural network encoder such that (a) input data belonging to a same class is close in an encoded space by a same class threshold amount, and (b) input data belonging to a different class is far in the encoded space by a different class threshold amount.

17. The computer program product of claim 11, wherein said learning step comprises optimizing the neural network encoder further such that (c) the input data belonging to different classes does not overlap in the encoded space.

18. The computer program product of claim 11, wherein the neural network encoder comprises at least one Long Short-Term Memory (LSTM).

19. The computer program product of claim 11, wherein said training step trains the K−1 binary classifiers such that a kₜₕ binary classifier is given by zₖ and is defined as:
$${z}_{k} ( f ( {x}_{i} ) ) = \{ \begin{matrix}1 , if {y}_{i} > k \\ 0\end{matrix} ,$$
where:
xᵢ: denotes the iₜₕ input;
yⱼ: denotes the ordinal label for xᵢ; and
k: denotes the number of the classifier being considered.

20. A computer processing system for ordinal classification of input data, comprising:
a memory device for storing program code thereon; and
a processor device, operatively coupled to the memory device, for running the program code to:
learn, by an encoder neural network implemented by the processor device, compact neural representations of the input data;
freeze the encoder neural network for downstream tasks;
train K−1 ordinal classifiers on top of the compact neural representations to obtained trained K−1 ordinal classifiers; and
generate a predicted ordinal label by aggregating the trained K−1 ordinal classifiers.
